(19) United States
(12) Patent Application Publication
(10) Pub. No.: US 2017/0206033 A1
(43) Pub. Date: Jul. 20, 2017

(54) MECHANISM ENABLING THE USE OF SLOW MEMORY TO ACHIEVE BYTE ADDRESSABILITY AND NEAR-DRAM PERFORMANCE WITH PAGE REMAPPING SCHEME

(71) Applicant: SK hynix Inc., Gyeonggi-do (KR)

(72) Inventors: Kenneth C. MA, Cupertino, CA (US); Dongwook SUH, Saratoga, CA (US)

(21) Appl. No.: 15/370,858

(22) Filed: Dec. 6, 2016

Related U.S. Application Data
(60) Provisional application No. 62/280,430, filed on Jan. 19, 2016.

(51) Int. Cl. G06F 3/06

(52) U.S. Cl. CPC G06F 3/0644; G06F 3/061; G06F 3/0647; G06F 3/0656; G06F 3/0659; G06F 3/0665; G06F 3/0685

(57) ABSTRACT

Memory systems may include a memory storage including a dynamic random access memory (DRAM) portion, a non-volatile memory (NVM) portion, and a virtual memory (VM), a software page remapping kernel driver (SPRKD) suitable for intercepting a memory management command, the memory management command including an access to a virtual address location of the VM, and remapping the virtual address location from a physical address of the NVM portion mapped to the virtual address location to a physical address of the DRAM portion, and a controller suitable for executing the memory management command by accessing the physical address of the DRAM portion to which the virtual address location is remapped.

### CROSS-REFERENCE TO RELATED APPLICATIONS

This application claims the benefit of U.S. Provisional Application No. 62/280,430 filed Jan. 19, 2016, the entire contents of which are incorporated herein by reference.

### BACKGROUND

1. Field

Exemplary embodiments of the present disclosure relate to a memory system and an operating method thereof.

2. Description of the Related Art

The computer environment paradigm has shifted to ubiquitous computing systems that can be used anytime and anywhere. Due to this fact, the use of portable electronic devices such as mobile phones, digital cameras, and notebook computers has rapidly increased. These portable electronic devices generally use a memory system having memory devices, that is, a data storage device. The data storage device is used as a main memory device or an auxiliary memory device of the portable electronic devices.

Data storage devices using memory devices provide excellent stability, durability, high information access speed, and low power consumption, since they have no moving parts. Examples of data storage devices having such advantages include universal serial bus (USB) memory devices, memory cards having various interfaces, and solid state drives (SSD).

DRAM density scaling has slowed, and the total DRAM capacity per system is not expected to surpass 2 TB per system in foreseeable future. Both the price and refresh power consumption for such high DRAM memory capacity will be prohibitive for a typical server. Thus, there exists a need for improved memory systems and utilization of DRAM.

### SUMMARY

Aspects of the invention include memory systems. The memory systems may include a memory storage including a dynamic random access memory (DRAM) portion, a non-volatile memory (NVM) portion, and a virtual memory (VM), a software page remapping kernel driver (SPRKD) suitable for intercepting a memory management command, the memory management command including an access to a virtual address location of the VM, and remapping the virtual address location from a physical address of the NVM portion mapped to the virtual address location to a physical address of the DRAM portion, and a controller suitable for executing the memory management command by accessing the physical address of the DRAM portion to which the virtual address location is remapped.

Further aspects of the invention include methods. The methods may include intercepting, with a software page remapping kernel driver (SPRKD), a memory management command, the memory management command including an access to a virtual address location of a virtual memory (VM), remapping, with the SPRKD, the virtual address location from a physical address of a non-volatile memory (NVM) portion of a memory storage that is mapped to the virtual address location to a physical address of a dynamic random access memory (DRAM) portion of the memory storage, and executing, with a controller, the memory management command by access the physical address of the DRAM portion to which the virtual address location is remapped.

Additional aspects of the invention include memory devices. The memory devices may include a memory storage including a dynamic random access memory (DRAM) portion, a non-volatile memory (NVM) portion, and a virtual memory (VM), a software page remapping kernel driver (SPRKD) configured to intercept a memory management command, the memory management command including an access to a virtual address location of the VM, and remap the virtual address location from a physical address of the NVM portion mapped to the virtual address location to a physical address of the DRAM portion, and a controller configured to execute the memory management command by accessing the physical address of the DRAM portion to which the virtual address location is remapped.

### BRIEF DESCRIPTION OF THE DRAWINGS

FIG. 1 is a block diagram schematically illustrating a memory system in accordance with an embodiment of the present invention.

FIG. 2 is a block diagram illustrating a memory system in accordance with an embodiment of the present invention.

FIG. 3 is a circuit diagram illustrating a memory block of a memory device in accordance with an embodiment of the present invention.

FIG. 4 is a diagram of an example system for page remapping in accordance with aspects of the invention.

FIG. 5 is a flowchart of an example command process according to aspects of the invention.

FIG. 6 is a diagram of a page remapping process according to aspects of the invention.

FIG. 7 is a flowchart of steps in a method for page remapping in accordance with aspects of the invention.

FIG. 8 is an algorithmic flowchart of a process for page remapping according to aspects of the invention.

FIG. 9 is a flowchart of an example page remapping process in accordance with aspects of the invention.

FIGS. 10A, 10B, and 10C are diagrams of example systems for page remapping according to aspects of the invention.

### DETAILED DESCRIPTION

Various embodiments will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

The invention can be implemented in numerous ways, including as a process; an apparatus; a system; a composition of matter; a computer program product embodied on a computer readable storage medium; and/or a processor, such as a processor suitable for executing instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being suitable for performing a task may be implemented as a general component that is temporarily suitable for performing the task at a given time or a specific component that is manufactured to perform the task. As used herein, the term ‘processor’ refers to one or more devices, circuits, and/or processing cores suitable for processing data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

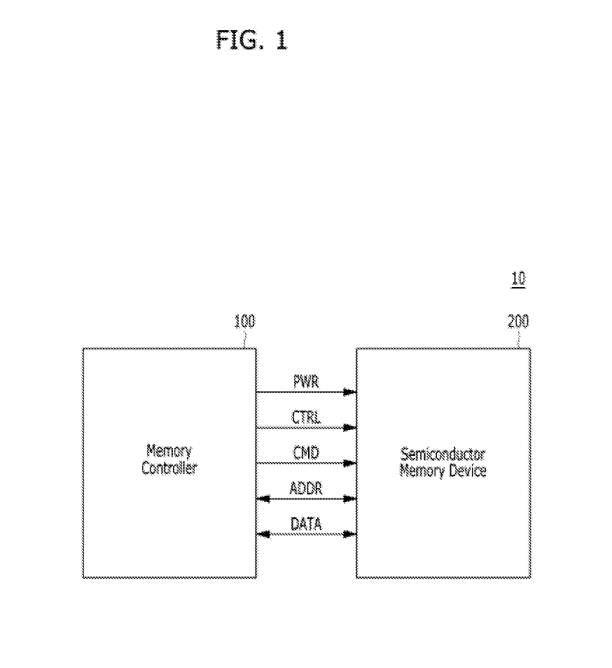

FIG. 1 is a block diagram schematically illustrating a memory system 10 in accordance with an embodiment of the present invention.

Referring FIG. 1, the memory system 10 may include a memory controller 100 and a semiconductor memory device 200.

The memory controller 100 may control overall operations of the semiconductor memory device 200.

The semiconductor memory device 200 may perform one or more erase, program, and read operations under the control of the memory controller 100. The semiconductor memory device 200 may receive a command CMD, an address ADDR and data DATA through input/output lines. The semiconductor memory device 200 may receive power PWR through a power line and a control signal CTRL through a control line. The control signal may include a command latch enable (CLE) signal, an address latch enable (ALE) signal, a chip enable (CE) signal, a write enable (WE) signal, a read enable (RE) signal, and so on.

The memory controller 100 and the semiconductor memory device 200 may be integrated in a single semiconductor device. For example, the memory controller 100 and the semiconductor memory device 200 may be integrated in a single semiconductor device such as a solid state drive (SSD). The solid state drive may include a storage device for storing data therein. When the semiconductor memory system 10 is used in an SSD, operation speed of a host (not shown) coupled to the memory system 10 may remarkably improve.

The memory controller 100 and the semiconductor memory device 200 may be integrated in a single semiconductor device such as a memory card. For example, the memory controller 100 and the semiconductor memory device 200 may be integrated in a single semiconductor device to configure a memory card such as a PC card of personal computer memory card international association (PCMCIA), a compact flash (CF) card, a smart media (SM) card, a memory stick, a multimedia card (MMC), a reduced-size multimedia card (RS-MMC), a micro-size version of MMC (MMCmicro), a secure digital (SD) card, a mini secure digital (miniSD) card, a micro secure digital (microSD) card, a secure digital high capacity (SDHC), and a universal flash storage (UFS).

For another example, the memory system 10 may be provided as one of various elements including an electronic device such as a computer, an ultra-mobile PC (UMPC), a workstation, a net-book computer, a personal digital assistant (PDA), a portable computer, a web tablet PC, a wireless phone, a mobile phone, a smart phone, an e-book reader, a portable multimedia player (PMP), a portable game device, a navigation device, a black box, a digital camera, a digital multimedia broadcasting (DMB) player, a 3-dimensional television, a smart television, a digital audio recorder, a digital audio player, a digital picture recorder, a digital picture player, a digital video recorder, a digital video player, a storage device of a data center, a device capable of receiving and transmitting information in a wireless environment, one of electronic devices of a home network, one of electronic devices of a computer network, one of electronic devices of a telematics network, a radio-frequency identification (RFID) device, or elements devices of a computing system.

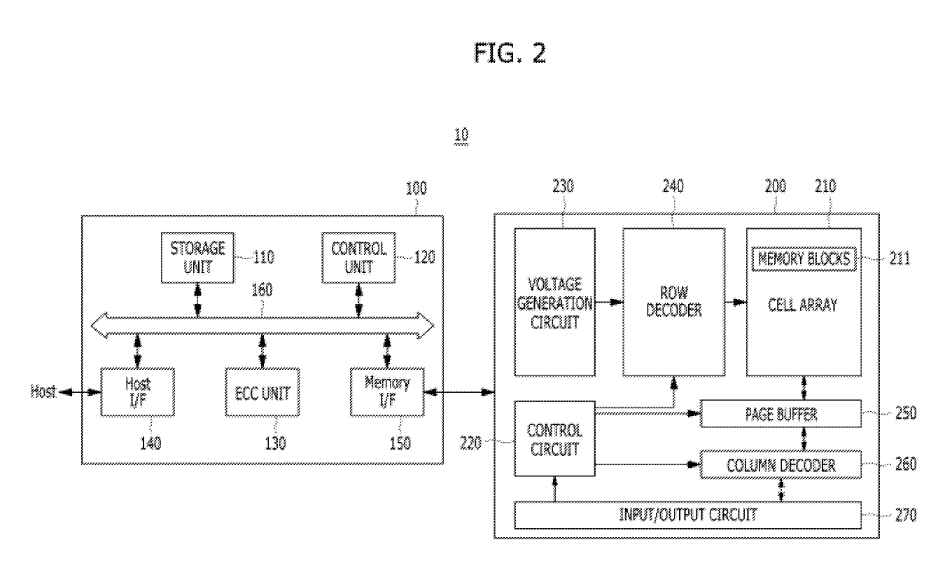

FIG. 2 is a detailed block diagram illustrating a memory system in accordance with an embodiment of the present invention. For example, the memory system of FIG. 2 may depict the memory system 10 shown in FIG. 1.

Referring to FIG. 2, the memory system 10 may include a memory controller 100 and a semiconductor memory device 200. The memory system 10 may operate in response to a request from a host device, and in particular, store data to be accessed by the host device.

The host device may be implemented with any one of various kinds of electronic devices. In some embodiments, the host device may include an electronic device such as a desktop computer, a workstation, a three-dimensional (3D) television, a smart television, a digital audio recorder, a digital audio player, a digital picture recorder, a digital picture player, a digital video recorder and a digital video player. In some embodiments, the host device may include a portable electronic device such as a mobile phone, a smart phone, an e-book, an MP3 player, a portable multimedia player (PMP), and a portable game player.

The memory device 200 may store data to be accessed by the host device.

The memory device 200 may be implemented with a volatile memory device such as a dynamic random access memory (DRAM) and a static random access memory (SRAM) or a non-volatile memory device such as a read only memory (ROM), a mask ROM (MROM), a programmable ROM (PROM), an erasable programmable ROM (EPROM), an electrically erasable programmable ROM (EEPROM), a ferroelectric random access memory (FRAM), a phase change RAM (PRAM), a magnetoresistive RAM (MRAM) and a resistive RAM (RRAM).

The controller 100 may control storage of data in the memory device 200. For example, the controller 100 may control the memory device 200 in response to a request from the host device. The controller 100 may provide the data read from the memory device 200, to the host device, and store the data provided from the host device into the memory device 200.

The controller 100 may include a storage unit 110, a control unit 120, the error correction code (ECC) unit 130, a host interface 140 and a memory interface 150, which are coupled through a bus 160.

The storage unit 110 may serve as a working memory of the memory system 10 and the controller 100, and store data for driving the memory system 10 and the controller 100. When the controller 100 controls operations of the memory device 200, the storage unit 110 may store data used by the controller 100 and the memory device 200 for such operations as read, write, program and erase operations.

The storage unit 110 may be implemented with a volatile memory. The storage unit 110 may be implemented with a static random access memory (SRAM) or a dynamic random access memory (DRAM). As described above, the storage unit 110 may store data used by the host device in the memory device 200 for the read and write operations. To store the data, the storage unit 110 may include a program memory, a data memory, a write buffer, a read buffer, a map buffer, and so forth.

The control unit 120 may control general operations of the memory system 10, and a write operation or a read operation for the memory device 200, in response to a write request or a read request from the host device. The control unit 120 may drive firmware, which is referred to as a flash translation layer (FTL), to control the general operations of the memory system 10. For example, the FTL may perform operations such as logical to physical (L2P) mapping, wear leveling, garbage collection, and bad block handling. The L2P mapping is known as logical block addressing (LBA).

The ECC unit 130 may detect and correct errors in the data read from the memory device 200 during the read operation. The ECC unit 130 may not correct error bits when the number of the error bits is greater than or equal to a threshold number of correctable error bits, and may output an error correction fail signal indicating failure in correcting the error bits.

In some embodiments, the ECC unit 130 may perform an error correction operation based on a coded modulation such as a low density parity check (LDPC) code, a Bose-Chaudhuri-Hocquenghem (BCH) code, a turbo code, a turbo product code (TPC), a Reed-Solomon (RS) code, a convolution code, a recursive systematic code (RSC), a trellis-coded modulation (TCM), a Block coded modulation (BCM), and so on. The ECC unit 130 may include all circuits, systems or devices for the error correction operation.

The host interface 140 may communicate with the host device through one or more of various interface protocols such as a universal serial bus (USB), a multi-media card (MMC), a peripheral component interconnect express (PCI-E), a small computer system interface (SCSI), a serial-attached SCSI (SAS), a serial advanced technology attachment (SATA), a parallel advanced technology attachment (PATA), an enhanced small disk interface (ESDI), and an integrated drive electronics (IDE).

The memory interface 150 may provide an interface between the controller 100 and the memory device 200 to allow the controller 100 to control the memory device 200 in response to a request from the host device. The memory interface 150 may generate control signals for the memory device 200 and process data under the control of the CPU 120. When the memory device 200 is a flash memory such as a NAND flash memory, the memory interface 150 may generate control signals for the memory and process data under the control of the CPU 120.

The memory device 200 may include a memory cell array 210, a control circuit 220, a voltage generation circuit 230, a row decoder 240, a page buffer 250, a column decoder 260, and an input/output circuit 270. The memory cell array 210 may include a plurality of memory blocks 211 and may store data therein. The voltage generation circuit 230, the row decoder 240, the page buffer 250, the column decoder 260 and the input/output circuit 270 form a peripheral circuit for the memory cell array 210. The peripheral circuit may perform a program, read, or erase operation of the memory cell array 210. The control circuit 220 may control the peripheral circuit.

The voltage generation circuit 230 may generate operation voltages having various levels. For example, in an erase operation, the voltage generation circuit 230 may generate operation voltages having various levels such as an erase voltage and a pass voltage.

The row decoder 240 may be connected to the voltage generation circuit 230, and the plurality of memory blocks 211. The row decoder 240 may select at least one memory block among the plurality of memory blocks 211 in response to a row address RADD generated by the control circuit 220, and transmit operation voltages supplied from the voltage generation circuit 230 to the selected memory blocks among the plurality of memory blocks 211.

The page buffer 250 is connected to the memory cell array 210 through bit lines BL (not shown). The page buffer 250 may precharge the bit lines BL with a positive voltage, transmit/receive data to/from a selected memory block in program and read operations, or temporarily store transmitted data, in response to a page buffer control signal generated by the control circuit 220.

The column decoder 260 may transmit/receive data to/from the page buffer 250 or transmit/receive data to/from the input/output circuit 270.

The input/output circuit 270 may transmit, to the control circuit 220, a command and an address, transmitted from an external device (e.g., the memory controller 100), transmit data from the external device to the column decoder 260, or output data from the column decoder 260 to the external device, through the input/output circuit 270.

The control circuit 220 may control the peripheral circuit in response to the command and the address.

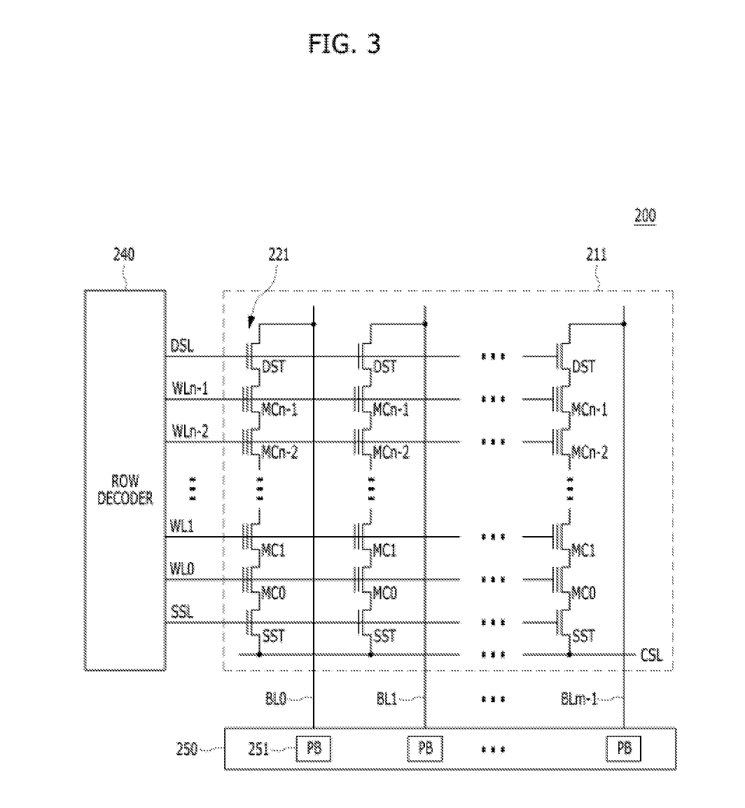

FIG. 3 is a circuit diagram illustrating a memory block of a semiconductor memory device in accordance with an embodiment of the present invention. For example, a memory block of FIG. 3 may be the memory blocks 211 of the memory cell array 200 shown in FIG. 2.

Referring to FIG. 3, the memory blocks 211 may include a plurality of cell strings 221 coupled to bit lines BL0 to BLm−1, respectively. The cell string of each column may include one or more drain selection transistors DST and one or more source selection transistors SST. A plurality of memory cells or memory cell transistors may be serially coupled between the selection transistors DST and SST. Each of the memory cells MC0 to MCn−1 may be formed of a multi-level cell (MLC) storing data information of multiple bits in each cell. The cell strings 221 may be electrically coupled to the corresponding bit lines BL0 to BLm−1, respectively.

In some embodiments, the memory blocks 211 may include a NAND-type flash memory cell. However, the memory blocks 211 are not limited to the NAND flash memory, but may include NOR-type flash memory, hybrid flash memory in which two or more types of memory cells are combined, and one-NAND flash memory in which a controller is embedded inside a memory chip.

The reason for pushing larger amount of memory is to enable use cases such as real-time business analytics, big graph processing, business intelligence, deep learning and many more applications which involves terabytes (TBs) of data. CPU computation is fast with data located inside DRAM (dynamic random access memory), but when the dataset is too big to fit into the DRAM, the OS (operating system) will grab the data from the disk drive (e.g., a non-volatile memory NVM). Traditional HDD (hard disk drives) have a very long mechanism latency of several milliseconds (which is ˜100000 times slower than DRAM) and can substantially slow the computing process. The popularity of SSD (solid state drives) has alleviated this somewhat but SSDs still have about a 100 microsecond latency (which is ˜1000 times slower than DRAM).

As disclosed herein, systems, methods, devices, and processes for page remapping achieve true random read/write accesses with byte addressability and near-DRAM performance with the need for any hardware changes. In particular, no changes are required for the host CPU, host memory controller (MEMC), or the memory channel interfaces (e.g., JEDEC, DDR4, etc.) as the invention disclosed herein is a pure software mechanism and is compatible with all hardware interface implementations.

The invention disclosed herein enables use of hybrid fast and slow memory to work together and acts transparent to the operating system as a much larger fast memory that support random access, byte-addressable memory despite the slow memory being a block-based memory like NAND Flash. For example, a hybrid memory DIMM with 32 GB DRAM and 512 GB NAND flash storage will have much lower cost than 64 GB DRAM, or 128 GB SCM storage class memory, but the OS will perceive it as greater than or equal to 512 GB byte-addressable fast memory and the systems may run applications effectively with much larger data sets that involves multiple TBs of data in a multiple DIMMs configurations.

The remapping is performed in a way that is transparent to the operating system (e.g., the remapping occurs before the memory management commands are executed). Therefore, the invention is compatible with OS-level NUMA mechanisms and with existing and further file systems (e.g., normal F/S, PM-Aware F/S, Linux DAX, native PM-Aware F/S, etc.).

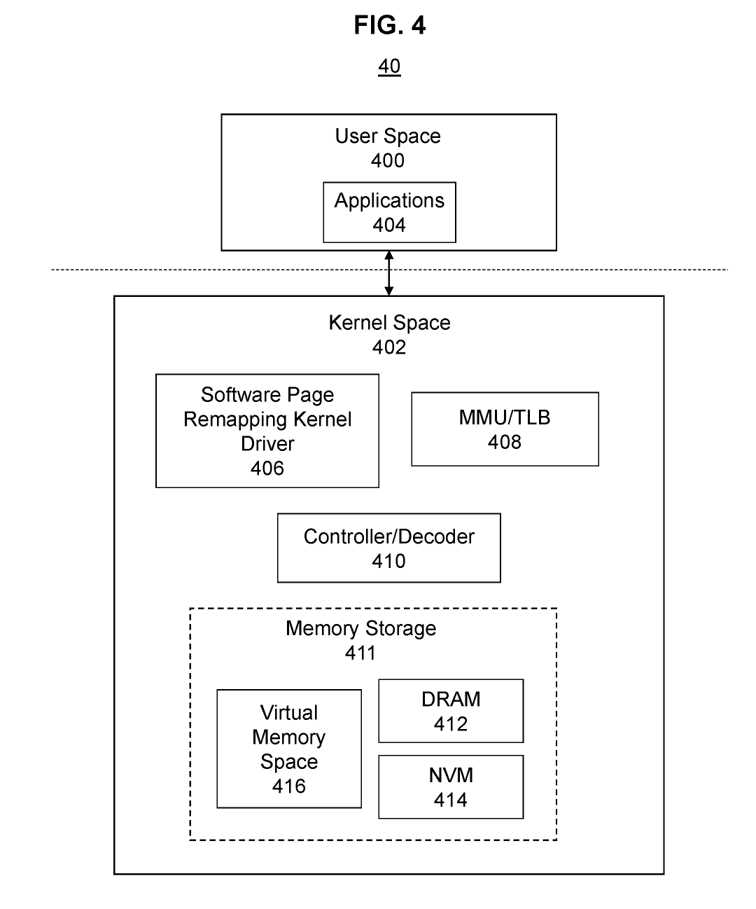

Referring generally to FIG. 4, a system 40 for page remapping is shown. The system 40 includes a user space 400 and a kernel space 402, where the user space 400 and the kernel space 402 are in communication. The user space 400 includes applications 404 which require the components of the kernel space 402 to run. The kernel space 402 includes a software page remapping kernel driver 406, a memory management unit (MMU)/translation lookaside buffer (408), a controller/decoder 410, and a memory storage portion 411. The memory storage portion 411 may include a DRAM portion 412, a NVM/NAND portion 414, and a virtual memory (VM) space. The DRAM portion 412 may be further sectioned to include a DRAM remap buffer portion (not shown). The components shown in the system 40 of FIG. 4 and their functionalities are described in detail below.

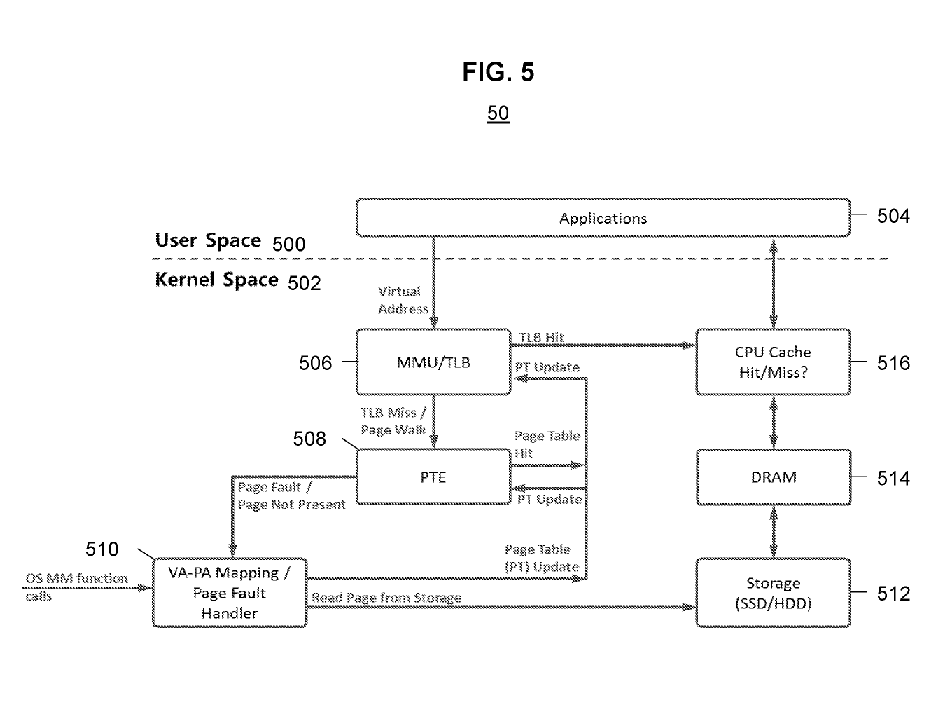

Referring next to FIG. 5, a diagram 50 of example CPU and OS operations is shown. As seen in FIG. 5, there is a user space 500 in which the applications 404 run, and a kernel space 502. In the operation, the utilized components may include an MMU/TLB 506, a page table (PT) including page table entries (PTE) 508, a virtual address (VA) to physical address (PA) mapping/page fault handler 510, a storage 512 (e.g., SSD, HDD, etc.), a DRAM 514, and a CPU cache 516.

As shown in FIG. 5, when the OS needs to change the VA to PA mapping, it will issue a memory management function call to update the page table and corresponding PTEs 508. Also, when there is a TLB miss or page fault, the MMU 506 may cause an “exception” which will trigger a TLB miss handler 510 to perform a “page walk” to see if the page is present in the PT or not.

If the page is present (e.g., a PT hit), the handler 510 will perform a TLB update. In general, a TLB is a cache of the translations from VM addresses to physical memory addresses. When a processor changes the virtual to physical mapping of an address, it may communicate to the other processors to invalidate that mapping in their respective caches. Such a process may be referred to a TLB shootdown. If a processor is updating its own TLB only, the process may be referred to as a TLB update.

If the page is not present (e.g., a PT miss), a page fault may be triggered and the handler 510 may receive the corresponding page(s) from the storage 512, update the VA to PA mapping in the PTE 508 and perform a TLB shootdown. The enables a virtual memory page located in the storage 512 to be accessible, either read or write, as if it is system memory.

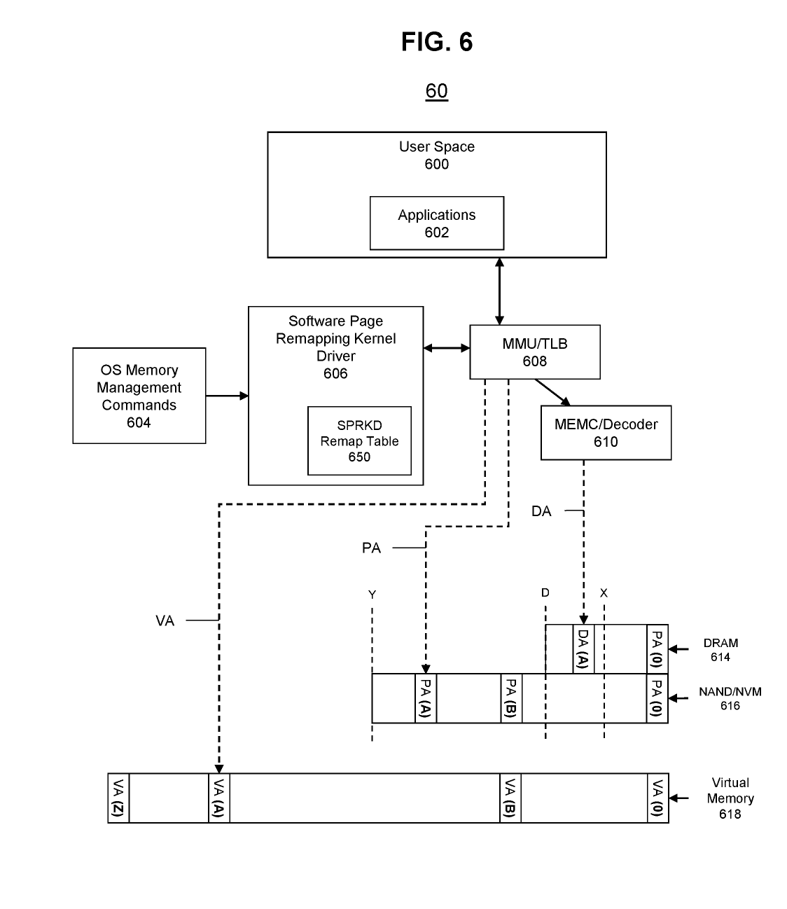

An example system 60 for page remapping is shown in FIG. 6 according to aspects of the invention disclosed herein. The system 60 includes a DRAM portion 614, a NAND/NVM portion 616, and a virtual memory VM 618. The physical space of the DRAM 614 is denoted as “D” (e.g., the amount of addresses from physical address 0 (PA(0)) to physical address D). Out of the D space, X amount of memory are mapped and visible to the OS. The portion between X and D may be referred to as a DRAM remap buffer portion.

The total amount of NVM memory is denoted as “Y” (e.g., the amount of addresses from physical address X to physical address Y). The amount of memory for the NVM portion 616 that is not allocated (previously mapped) in the DRAM is Y−X. Thus, the OS see the total amount of physical memory as X+Y.

The VM 618 has a perceived space of “Z” (e.g., the amount of addresses from VA (0) to VA (Z)).

In a typical OS environment, when the OS accesses (or allocates) the virtual memory location VA (A), if the page containing “A” is not already mapped to the system memory, the OS will generate a page fault and may retrieve that page from storage to copy it to the system memory. However, since the OS perceives the total system memory of X+Y as seen in FIG. 6, if the memory page allocated falls into the NVM address range (e.g., between X and Y), the subsequent read/write access to that page may be very slow for several reasons. For example, the NVM or NAND is substantially slower than the DRAM, each read/write access involves a page (block mode) access and is not byte addressable, and it needs to call a block mode driver to perform a block mode access.

The invention utilizes a software page remap kernel driver (SPRKD) to ensure all subsequent accesses to the slow memory (e.g., NVM portion 616) are redirected to the DRAM portion 614 transparently to emulate or cause the entire NAND/NVM address space (the space between X and Y) to be operable like the fast DRAM, supporting random, byte addressable read/write accesses.

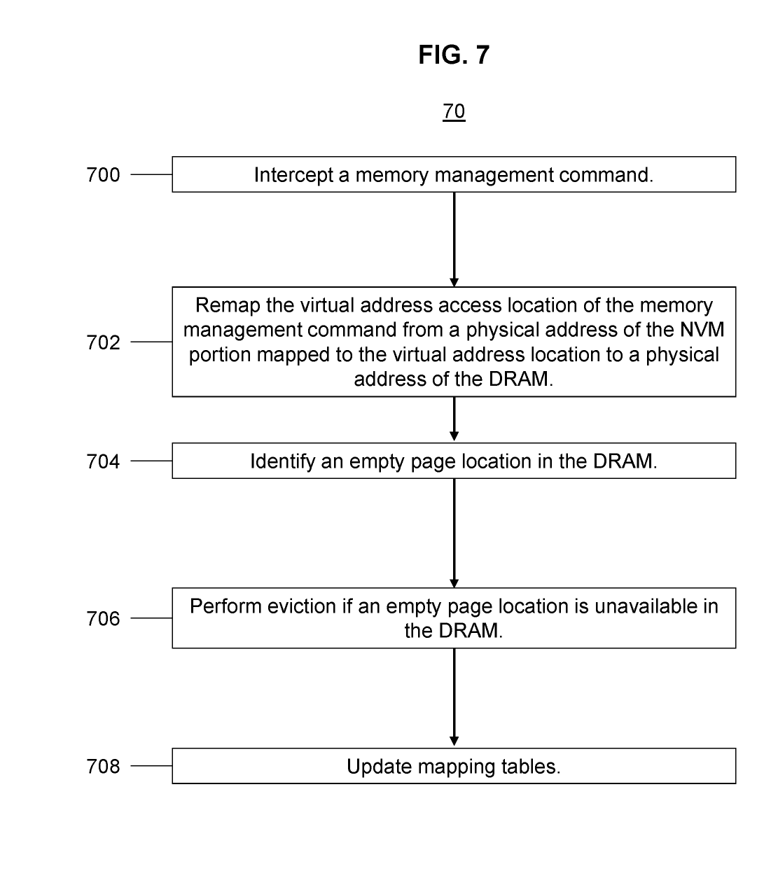

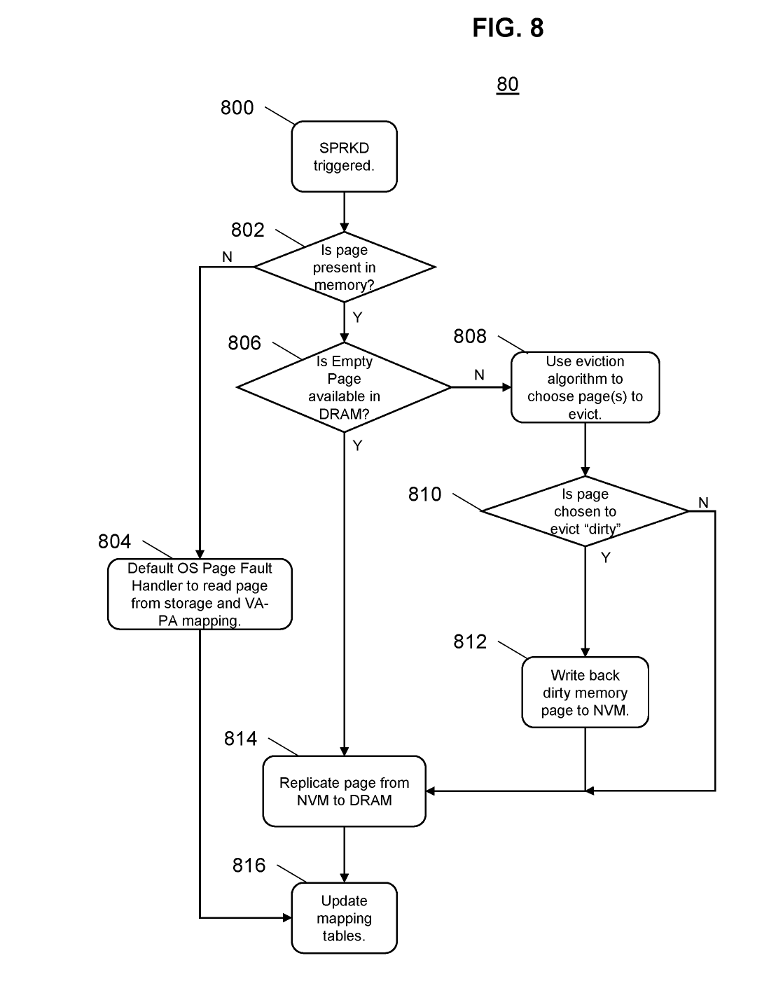

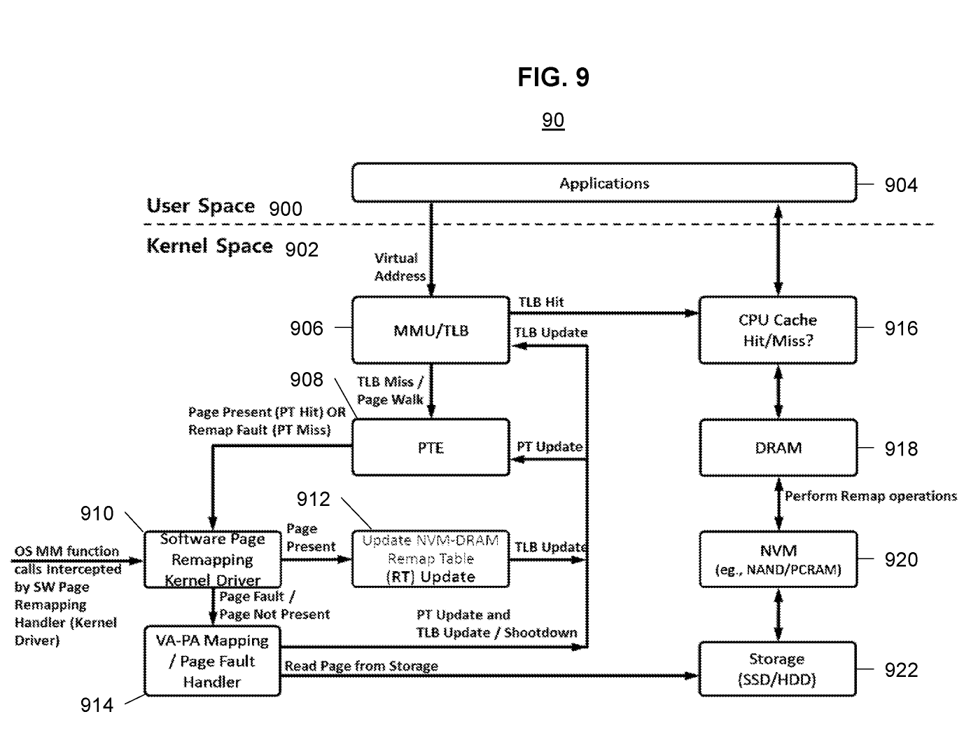

Embodiments of the invention are described with respect to FIGS. 6, 7, 8, and 9. FIG. 7 is a flowchart 70 of steps for page remapping. FIG. 8 is an algorithmic flowchart 80 of steps in a process for remapping and eviction. FIG. 9 is a diagram 90 of the remapping process.

At step 700, a memory management command is intercepted. The memory management command 604 may be intercepted by the SPRKD 606. For example, the memory management command 604 may include a command or access that maps the VA=“0 to Z” to physical addresses (PA)=“X to Y” of the NAND portion 616.

At step 702, the virtual address access location of the memory management command is remapped from a physical address of the NVM portion mapped to the virtual address location to a physical address of the DRAM portion. For example, the remapping may be performed by the SPRKD 606. SPRKD 606 may be configured to perform the remapping according to the properties of the memory management commands 604. For example, when the memory management command 604 maps VA=“0 to Z” to PA=“X to Y” (mapping the virtual addresses to the slow NVM portion), the SPRKD 606 may be configured to convert the mapping of VA=“0 to Z” to PA=“X to D”, putting the mapping in DRAM portion so all accesses to VA=“0 to Z” TB will be redirected to the DRAM portion between X to D (e.g., to the DRAM remap buffer portion).

In another example, the memory management command 604 may include an access to a location or group of locations in the VM space 618. In FIG. 6, the access may be to the location of VA (A), which may be previously mapped to physical address PA (A), which is positioned in the slow NVM portion 616. Thus, the SPRKD 606 may be configured to remap the VA (A) to a location in the DRAM portion 614 (e.g., DRAM Address (DA) DA(A)). Thus, the command is then executed by the MMU 608 via the MEMC/Decoder 610 by accessing the location in the DRAM DA (A).

At step 704, when the remapping is to be performed, an empty page location in the DRAM may be identified. The SPRKD 606 may be configured to identify an empty page location. If an empty page is available in the DRAM 614, the SPRKD 606 performs the remapping, which can be done by simple page replication to copy the page in the NVM 616 to the empty page in the DRAM 614. The SPRKD 606 may be configured to identify an empty page location in the DRAM remap buffer portion (e.g., X to D) of the DRAM 614.

At step 706, an eviction may be performed if an empty page location is unavailable in the DRAM. The SPRKD 606 may be configured to perform the eviction according to an eviction algorithm.

The process of steps 704 and 706 are described in further detail with reference to the flowchart 80 of FIG. 8.

The flowchart 80 of FIG. 8 depicts algorithmic steps for identifying empty pages/page locations in a memory and an eviction process when empty pages are not available.

At step 800, the SPRKD is triggered, such as SPRKD 606. The SPRKD may be triggered by events such as those described above (e.g., by a TLB miss handler, by intercepting OS MM commands, etc.). The SPRKD may be triggered at step 800 to at least, inter alia, ensure the VA to PA mapping is properly remapped to an allocated DRAM remap buffer space. The SPRKD may be triggered at step 800 to read/access a page/pages of data.

At step 802, it is determined whether the page is present in the memory. For example, the SPRKD may be configured to determine whether the page is present in the memory. In particular, at step 802, it may be determined whether the page(s) to be accessed are present in the DRAM 614/NVM 616. Put alternatively, the SPRKD may be configured to determine if the OS access is to a page location that is part of the VM space 681 and has not yet been mapped to the DRAM 614 or the NVM 616.

If the page is not present in the memory, then at step 804, a default OS page fault handler 510 may be used to read the page from the storage and VA-PA remapping may be performed. For example, the VA-PA remapping may be performed by the SKRPD. If the OS access a VA location (for example, VA (A) in FIG. 6) that is not yet mapped, the MMU 608 may be configured to generate a page fault, and the SPRKD 606 may be configured to perform the DRAM remapping such that the VA location is remapped to the DRAM for accessing (e.g., remapping VA (A) to DA [DRAM Address] (A)). The SPRKD 606 may be configured to read the page from storage, copy the page to the NVM 616 and/or the DRAM 614, etc. The SPRKD 606 may be configured to perform the DRAM remap and then pass the original OS page fault handler 510 that the SPRKD 606 intercepted to handle the remaining operations.

At step 806, if the page (VM access) is present in the memory (e.g., the page has been previously mapped to the NVM 616 or DRAM 614 space), then it is determined whether an empty page is available in the DRAM. For example, the SPRKD 606 may determine whether there are empty pages in the DRAM 614.

In some embodiments, step 806 may occur in several sub steps. For example, if the VM address is mapped to the DRAM 614 between addresses 0 and X, then the access may be directed to the DRAM as normal, since this access will already be accessing the fast speed memory.

If the VM address is mapped to the NVM space 616 (e.g., in spaces with addresses between X and Y), the access will be remapped to the DRAM 614 between X and D as followed:

If a page is already in the DRAM remap buffer, then the access will be redirected to DRAM address X to D;

if the page has been unmapped/evicted, the TLB miss will trigger the SPRKD to perform a page remap.

Thus, at step 806, if there is an empty page available in the DRAM, then, at step 814, the SPRKD may replicate the page from the NVM space 616 to the DRAM space 614 so that the access to the page will be redirected to the fast memory space of the DRAM 616. If, at step 806, there is no empty page available in the DRAM 616, then the SPRKD 606 may proceed to an eviction algorithm as described at steps 808, 810, and 812.

As described at steps 808, 810, and 812, pages may be chosen as “clean” or “dirty”. Thus, at step 808, the eviction algorithm begins to choose a page(s) to evict. If a page chosen is clean at step 810, the page can be discarded from the DRAM and the page replication from the NVM to the DRAM performed at step 814 can be performed. If the page chosen at step 810 is dirty, then the dirty page is written back to the NVM space 616 (e.g., the page needs to be continued to be stored rather than simply discarded or completely empty of data), and the page replication from the NVM to the DRAM can occur at step 814.

Following each of steps 814 or 804, mapping tables may be updated. The SPRKD may be configured to update mapping tables such as those described above according to the remapping of pages. In some embodiments, the SPRKD 606 is configured to maintain its own remapping table, (e.g., SPRKD remap table 650) such that the remap table 650 is updated at step 816.

Referring next to FIG. 9, an example system 90 of CPU and OS operations updated with the implementation of the SPRKD as opposed to the system 50 of FIG. 5 is shown. As seen in FIG. 9, there is a user space 900 where applications 904 run, and a kernel space 902. The system 90 includes functionality of an MMU/TLB 906, a PTE 908, a VA-PA mapping/page fault handler 914, and a storage 922, DRAM 918, and a CPU hit/miss check 916. The system 90 includes (in addition to the system 50), accesses to the NVM 920 when necessary for remapping functions, a SPRKD 910, and a remap table 912 along with a function for updating the remap table 912.

Since the SPRKD 910 will convert all accesses to NAND/NVM address space and remap them to the DRAM remap buffer space at “X to D” GB, OS accesses to slow memory space are always remapped (redirected) to DRAM such that the OS thinks it is accessing fast, byte-addressable DRAM memory.

In general, the SPRKD 910 may be configured to perform two functions. First, the SPRKD 910 intercepts the OS MM function calls. When OS needs to change the VA (virtual address) to PA (physical address) mapping, the SPRKD 910 will check if the page is present in the NVM-DRAM Remap Table 912 first. If hit, it will perform “RT Update” (Remap Table Update) to the PTE 908 and TLB 906 using the RT (Remap Table) info. If miss, it will treat it as Page Fault and pass it to the OS Page Fault handler 914.

Second, in a normal TLB miss, the TLB miss handler will perform a “page walk” to determine if a page is mapped in PT (hit) or not in the PT (miss, which will be treated as “remap fault”) and then passed to the SPRKD 910. At the SPRKD 910, for a PT hit, it may be configured to perform a remap, update the remap table 912 and perform a TLB updated. At the SPRKD 910, for a PT miss, it may be configured to perform a similar action as the page fault to load the page from storage, perform VA-PA mapping, PT update, TLB shootdown to other processors, TLB update to the target processor, and then retry the memory access that triggers the TLB miss.

Since the invention disclosed herein can utilize the TLB dirty bit to determine if a remapped DRAM page to be evicted needs to be first written back to NAND/NVM, it will have good performance for read-intensive applications. However, in write-intensive and low locality applications, it may generate a large number of remap operations with many dirty pages. Thus, alternative eviction algorithms may be utilized as disclosed below.

In one embodiment, the SPRKD 910 can check the “dirty” bit in the TLB to substantially improve performance, especially for Read-Intensive apps like Page Rank, Histogram etc., where there are many reads (so most pages are clean) but only writes a small amount of data (very few dirty pages) and typically those writes are not written to the source data locations. Not only does this substantially improve performance, but it also reduces the wear to the NAND/NVM media.

In one embodiment, evicting a dirty page does not write-back to NAND/NVM immediately but instead marks that page as evicted and the SPRKD 910 can perform the write-back in future “trigger” of the SPRKD 910 to write-back opportunistically. This will work well when the eviction is not due to lack of empty remap buffer pages. For example, the SPRKD 910 can evict opportunistically and always try to leave “N” empty pages to handle applications with higher random access patterns.

In one embodiment, evicting a dirty page does not actually write-back to NAND/NVM but instead is copied to a “Eviction Buffer” which can either be logic gates inside the controller, internal or external SRAM, DRAM or other forms of temporary storage to make room for DRAM remap buffers. The eviction buffer is an effective way to manage the eviction latency of dirty pages since write-back to NAND/NVM may be slow. The SPRKD 910 may, in future “trigger” events, write-back to NAND/NVM opportunistically. In one embodiment, there may be a software driver that runs a software thread that will periodically clean up the above mentioned Eviction Buffer.

In another embodiment, if there are a logic circuit (e.g., RCD in RDIMM or LRDIMM, or some controller ASIC) that can track the read/write accesses to a remapped page in DRAM, it can (1) use any write to a page to set a “dirty” bit and mark that page as dirty and (2) count the number of read and write accesses to a page (or a group of pages) to determine hotness/warmness/coldness of the page (or group) to assist the eviction algorithm or eviction policy.

Since NAND Write is ˜7×-8× slower than read, it takes much longer to write to NAND, and thus dirty pages should be kept in DRAM as long as possible. Some NVM media similarly has writes much slower than reads, such as PCRAM.

In some embodiments, the eviction algorithm prioritizes eviction of clean pages based on page temperature and “cleanness”. An example order, where hot/dirty pages are the last to be evicted, may include (1) clean, cold pages; (2) clean, warm pages; (3) dirty, cold pages; (4) dirty, warm pages; (5) clean, hot pages; (6) dirty, hot pages, etc. The ordering and conditions of the eviction conditions may vary and be alternated and adjusted without diverting from the inventive aspects disclosed herein. The thresholds may be adjusted dynamically.

In one embodiment, the SPRKD 910 may be configured to dynamically adjust the replacement order intelligently, algorithmically or statistically based on access history and totally “time spent” on the eviction. The SPRKD 910 (and/or the dedicated software driver/thread) may be configured to initiate opportunistic write-back of “dirty, cold pages” to the NVM and mark the page as a clean, cold page so it may become the next candidate to be evicted. Put alternatively, the systems may be configured to tag pages with particular conditions to alter the page(s)′ eviction order.

In one embodiment, the OS may attempt to access a VM address location (e.g., VA (B) of FIG. 6) that is already mapped to an NVM 616 location (e.g., PA (B)) but has been unmapped (evicted) from the DRAM remap buffer space.

If the CPU supports software TLB Miss handling option, when the SPRKD 910 unmaps a page, it will perform the TLB shootdown such that, any subsequent access to (B) will generate a TLB Miss, which will then trigger the SPRKD 910 which will perform the DRAM Remap again. This way, the SPRKD 910 can guarantee all accesses to “0-Z” TB VA space will always be directed to DRAM address between “0 to D” GB.

If the CPU only supports hardware TLB Miss handling option, when the SPRKD 910 unmaps a page, it can keep the data page in NAND/NVM, and update the metadata that indicates that page is VALID. However, it will remove the corresponding entry in PTE (i.e., OS-managed PTE and/or locally managed PTE depends on implementation) so that hardware page table walker will generate a Page Fault, which will trigger the SPRKD 910 which will perform the remapping function. Since the valid data of the page still resides in NAND/NVM, the SPRKD 910 only needs to update the TLB entry and the metadata relevant to that page accordingly.

During “Page Replication” or “Eviction with write-back” process, it involves block read and block write to the NAND/NVM media respectively. To perform block mode access on DRAM memory interface channel, it can use trivial method using MMIO (Memory-Mapped IO) registers or buffer space to communicate with the controller that manages the NAND/NVM on (1) the command (e.g., read or writes), (2) data buffer or FIFO (e.g., page buffer or block storage) and (3) the completion status handshaking, e.g., by software polling a “completion status register”.

In an example, the completion status register can provide either estimates completion time if it can provide an good estimates how long the block access will take or a “recommendation polling interval” so the CPU can go off and do other useful works before the next polling. This will further improve the system performance by reducing unnecessary CPU polling. In another example, the MMIO registers may use a command format with embedded data instead of splitting into separate command and data buffer spaces. The “completion status register” may be in the MMIO space for command registers.

The inventions disclosed herein additionally permit flexible DRAM remap buffer usage and flexible memory address mapping. The amount of DRAM used as a remap buffer is typically flexible and not limited to the single example shown in FIG. 6. Rather, alternative configurations may be utilized, such as (1) flat DRAM and NVM (all are visible to the OS and in this configuration, X=D, remap buffer pages are marked as reserved); (2) DRAM partially visible and partially as remap buffer (D>X>0); (3) DRAM is completely invisible and all used as remap buffer (e.g., X=0); and/or other suitable configurations as will be understood by those of skill in the art from the disclosure herein.

As an example, in FIG. 6, if the DRAM remap buffer is not visible to the OS and the DRAM space from X to D−X is not visible, then the total OS visible memory is the space between X and Y. For another example, if X=D where all the DRAM are mapped and visible to the OS, the DRAM pages to be used as a remap page buffer may simply be marked as reserved, just like the “640 KB-1 MB” in a PC are marked as reserved in some OS's. In one example, the system may utilize UEFI to configure part of the DRAM to be not visible by the OS.

The remap buffer space may not need to be contiguous, but rather it can have multiple (e.g., “N”) non-contiguous address regions allocated for remap, although “N” should not be a large number to reduce the SPRKD overhead (e.g., N<=10).

Therefore, this systems, methods, processes and devices disclosed herein can use slow memory (e.g., NAND Flash, PCRAM) to emulate Byte Addressability and Near-DRAM performance, advantageously, with the need to change the Host CPU, Host MEMC and Memory Interface channel by “hiding” the undeterminstic latency of NAND/NVM accesses by the SPRKD Remap process, because during that time, the “access” is stalled and the “access” will only restart after the remap process is completed.

The inventions disclosed herein can be extended to support “slow memory” that are located on different CPU socket (e.g., through Intel QPI or UPI in a 2-socket server) or on a remote Server or a so-called “Pooled Memory server” such that, if a slow memory (e.g., NAND) is mapped and visible to the OS as “byte addressable” memory, and if the OS allocates a VA page to the slow memory, the SPRKD, technically, can intercept and perform the remap using the DRAM in the local socket. However, while technically feasible, the SPRKD doesn't know where are the applications will be running so it is better left for the OS and the respective NUMA functions to handle that. As noted above, this invention is compatible OS NUMA function since the “secondary translation” is transparent to the OS, and by definition, it is transparent to the NUMA function as well.

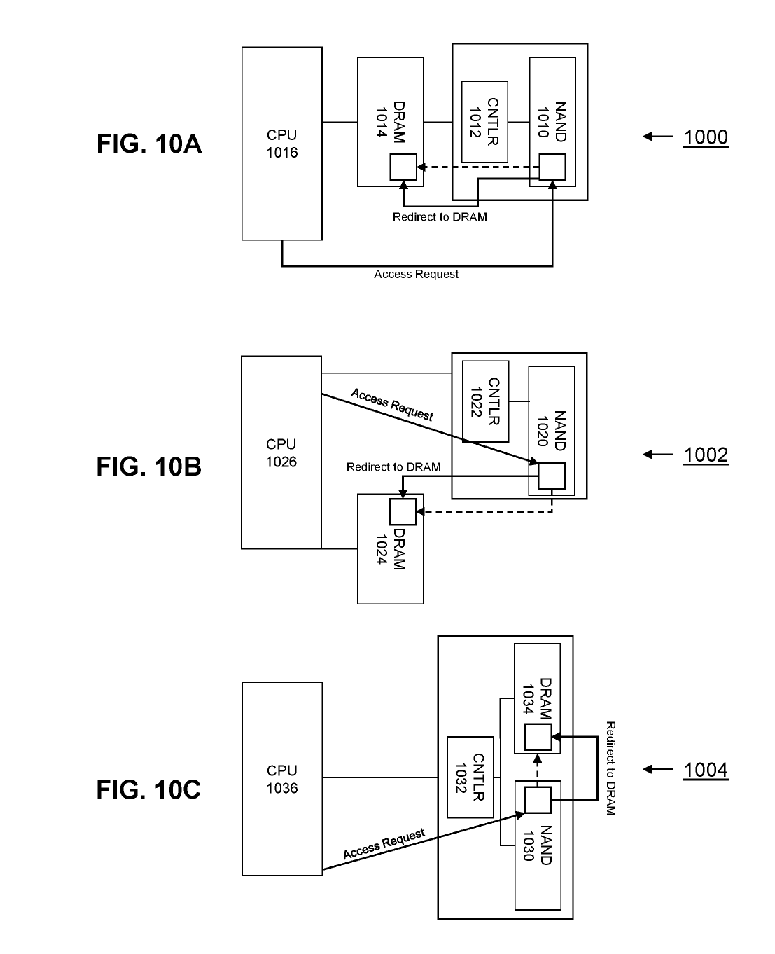

Referring next to FIGS. 10A, 10B, and 10C, example topologies/architectures of the systems, processes, methods, and devices disclosed above are shown. Three configurations 1000, 1002, and 1004 are shown, although this is meant to be exemplary and not exclusive. Other suitable configurations of components to effectuate the invention will be understood to those of skill in the art from the disclosure herein.

In a typical server system, there can be multiple memory channels, and each memory channel can typically install 2 or even 3 memory DIMM modules. The invention disclosed herein can support a wide variety of DRAM and NAND/NVM topologies, configurations, and address mapping options.

Configuration 1000 includes a NAND 1010, a controller 1012, a DRAM 1014 and a CPU 1016. The DRAM DIMM and NAND/NVM DIMM are on the same memory channel but on separate DIMMs, and accesses are redirected from the NAND 1010 to the DRAM 1014.

Configuration 1002 includes a NAND 1020, a controller 1022, a DRAM 1024 and a CPU 1026. The NAND 1020 and DRAM 1024 are on separate DIMMs and on separate memory channels (e.g., separate channels with respect to the CPU 1026).

Configuration 1004 includes a NAND 1030, a controller 1032, a DRAM 1034 and a CPU 1036. The NAND 1030 and the DRAM 1034 are co-located on the same module (e.g., the same DIMM).

In example of the invention where the Host CPU/SOC and the DRAM and NAND/NVM DIMMs modules are compatible with each other whether perform the Load/Store operations or Block mode Read/Write operations, this invention will be compatible with all of them. Hence, this invention can support a variety of DRAM and NAND/NVM DIMMs including but not limited JEDEC compatible DRAM DIMMs, eg., DDR3, DDR4 and future standards; JEDEC compatible NVDIMM-N, NVDIMM-F and future NVDIMM-P; Proprietary DRAM modules, eg., IBM/OpenPOWER DMI modules; Proprietary NAND/NVM modules on JEDEC DDR3, DDR4 and future standards; Proprietary NAND/NVM modules on non-JEDEC memory interfaces; etc.

If an application is “Software Page Remapping-Aware”, it can be written so that when it completes a task and can release all relevant pages to that task, it can issue command to an SPRKD to release the remapped pages and write-back the pages to NAND/NVM (if dirty). (Similar to “unmap” function in Linux).

Although the description above uses NAND Flash memory type as example, for those skilled in the art, it will be clear that this invention can be implemented using any types of NVM media such as NAND, PCRAM, RRAM or other future media types.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A memory system, comprising:
a memory storage including a dynamic random access memory (DRAM) portion, a non-volatile memory (NVM) portion, and a virtual memory (VM);
a software page remapping kernel driver (SPRKD) suitable for:
intercepting a memory management command, the memory management command including an access to a virtual address location of the VM; and
remapping the virtual address location from a physical address of the NVM portion mapped to the virtual address location to a physical address of the DRAM portion; and
a controller suitable for executing the memory management command by accessing the physical address of the DRAM portion to which the virtual address location is remapped.

2. The memory system of claim 1, wherein the remapping includes identifying an empty page location in the DRAM portion.

3. The memory system of claim 2, wherein the remapping includes performing an eviction of a page in the DRAM portion when an empty page location is unavailable in the DRAM portion.

4. The memory system of claim 3, wherein the eviction includes:
discarding the page on which the eviction is being performed when the page is determined to be clean; and
writing back the page on which the eviction is being performed to the NVM portion when the page is determined to be dirty.

5. The memory system of claim 1, wherein the SPRKD is further suitable for updating a map table following a remapping.

6. The memory system of claim 1, wherein the SPRKD is further suitable for redirecting the access of the memory management command to the DRAM portion when the virtual address location of the access is mapped to a physical address of the DRAM portion.

7. The memory system of claim 1, wherein the DRAM portion includes a DRAM remap buffer portion to which the remapping of the SPRKD is performed.

8. A method, comprising:
intercepting, with a software page remapping kernel driver (SPRKD), a memory management command, the memory management command including an access to a virtual address location of a virtual memory (VM);
remapping, with the SPRKD, the virtual address location from a physical address of a non-volatile memory (NVM) portion of a memory storage that is mapped to the virtual address location to a physical address of a dynamic random access memory (DRAM) portion of the memory storage; and
executing, with a controller, the memory management command by access the physical address of the DRAM portion to which the virtual address location is remapped.

9. The method of claim 8, wherein the remapping includes identifying an empty page location in the DRAM portion.

10. The method of claim 9, wherein the remapping includes performing an eviction of a page in the DRAM portion when an empty page location is unavailable in the DRAM portion.

11. The method of claim 10, wherein the eviction includes:
discarding the page on which the eviction is being performed when the page is determined to be clean; and
writing back the page on which the eviction is being performed to the NVM portion when the page is determined to be dirty.

12. The method of claim 8, further comprising updating, with the SPRKD, a map table following the remapping.

13. The method of claim 8, further comprising redirecting, with the SPRKD, the access of the memory management command to the DRAM portion when the virtual address location of the access is mapped to a physical address of the DRAM portion.

14. The method of claim 8, wherein the DRAM portion includes a DRAM remap buffer portion to which the remapping of the SPRKD is performed.

15. A memory device, comprising:
a memory storage including a dynamic random access memory (DRAM) portion, a non-volatile memory (NVM) portion, and a virtual memory (VM);
a software page remapping kernel driver (SPRKD) configured to:
intercept a memory management command, the memory management command including an access to a virtual address location of the VM; and
remap the virtual address location from a physical address of the NVM portion mapped to the virtual address location to a physical address of the DRAM portion; and
a controller configured to execute the memory management command by accessing the physical address of the DRAM portion to which the virtual address location is remapped.

16. The memory device of claim 15, wherein the remapping includes identifying an empty page location in the DRAM portion.

17. The memory device of claim 16, wherein the remapping includes performing an eviction of a page in the DRAM portion when an empty page location is unavailable in the DRAM portion.

18. The memory device of claim 17, wherein the eviction includes discarding the page on which the eviction is being performed when the page is determined to be clean; and
writing back the page on which the eviction is being performed to the NVM portion when the page is determined to be dirty.

19. The memory device of claim 15, wherein the SPRKD is further configured to update a map table following a remapping.

20. The memory device of claim 15, wherein the DRAM portion includes a DRAM remap buffer portion to which the remapping of the SPRKD is performed.
